(19) United States
(12) Patent Application Publication
(10) Pub. No.: US 2006/0083961 A1
(43) Pub. Date: Apr. 20, 2006

(54) Asynchronous diagnostics in a fuel cell or fuel cell system

(76) Inventors: Nick Piccirillo, Scotia, NY (US); Jim Carucci, New Hartford, NY (US); John Piccirillo, Schenectady, NY (US); Dustan Skidmore, Latham, NY (US); John Parks, Loundonville, NY (US); Michael Penev, Albany, NY (US)

Correspondence Address: FISH & RICHARDSON PC, P.O. BOX 1022, MINNEAPOLIS, MN, 55440-1022, US

(21) Appl. No.: 10/966,608

(22) Filed: Oct. 14, 2004

(51) Int. Cl. H01M 8/04

(52) U.S. Cl. 429/13; 429/22

(57) ABSTRACT

Methods including entering a diagnostic mode of a fuel cell in response to an asynchronous event are disclosed.

### TECHNICAL FIELD

The invention relates to methods of asynchronous diagnostics in a fuel cell or fuel cell system, as well as related fuel cells and fuel cell systems.

### BACKGROUND

A fuel cell can convert chemical energy to electrical energy by promoting electrochemical reactions between two reactants.

One type of fuel cell includes a cathode flow field plate, an anode flow field plate, a membrane electrode assembly disposed between the cathode flow field plate and the anode flow field plate, and two gas diffusion layers disposed between the cathode flow field plate and the anode flow field plate. A fuel cell can also include one or more coolant flow field plates disposed adjacent the exterior of the anode flow field plate and/or the exterior of the cathode flow field plate.

Each flow field plate has an inlet region, an outlet region and open-faced channels connecting the inlet region to the outlet region and providing a way for distributing the gases to the membrane electrode assembly.

The membrane electrode assembly usually includes a solid electrolyte (e.g., a proton exchange membrane, commonly abbreviated as a PEM) between a first catalyst and a second catalyst. One gas diffusion layer is between the first catalyst and the anode flow field plate, and the other gas diffusion layer is between the second catalyst and the cathode flow field plate.

During operation of the fuel cell, one of the gases (the anode gas) enters the anode flow field plate at the inlet region of the anode flow field plate and flows through the channels of the anode flow field plate toward the outlet region of the anode flow field plate. The other gas (the cathode gas) enters the cathode flow field plate at the inlet region of the cathode flow field plate and flows through the channels of the cathode flow field plate toward the cathode flow field plate outlet region.

As the anode gas flows through the channels of the anode flow field plate, the anode gas diffuses through the anode gas diffusion layer and interacts with the anode catalyst. Similarly, as the cathode gas flows through the channels of the cathode flow field plate, the cathode gas diffuses through the cathode gas diffusion layer and interacts with the cathode catalyst.

The anode catalyst interacts with the anode gas to catalyze the conversion of the anode gas to reaction intermediates. The reaction intermediates include ions and electrons. The cathode catalyst interacts with the cathode gas and the anode reaction intermediates to catalyze the conversion of the cathode gas to the chemical product of the fuel cell reaction.

The chemical product of the fuel cell reaction flows through a gas diffusion layer to the channels of a flow field plate (e.g., the cathode flow field plate). The chemical product then flows along the channels of the flow field plate toward the outlet region of the flow field plate.

The electrolyte provides a barrier to the flow of the electrons and gases from one side of the membrane electrode assembly to the other side of the membrane electrode assembly. However, the electrolyte allows ionic reaction intermediates to flow from the anode side of the membrane electrode assembly to the cathode side of the membrane electrode assembly.

Therefore, the ionic reaction intermediates can flow from the anode side of the membrane electrode assembly to the cathode side of the membrane electrode assembly without exiting the fuel cell. In contrast, the electrons flow from the anode side of the membrane electrode assembly to the cathode side of the membrane electrode assembly by electrically connecting an external load between the anode flow field plate and the cathode flow field plate. The external load allows the electrons to flow from the anode side of the membrane electrode assembly, through the anode flow field plate, through the load, to the cathode flow field plate, and to the cathode side of the membrane electrode assembly.

Electrons are formed at the anode side of the membrane electrode assembly, indicating that the anode gas undergoes oxidation during the fuel cell reaction. Electrons are consumed at the cathode side of the membrane electrode assembly, indicating that the cathode gas undergoes reduction during the fuel cell reaction.

For example, when hydrogen and oxygen are the gases used in a fuel cell, hydrogen flows through the anode flow field plate and undergoes oxidation. Oxygen flows through the cathode flow field plate and undergoes reduction. The specific reactions that occur in the fuel cell are represented in equations 1-3.
H₂→2H⁺+2e⁻ (1)
½O₂+2H⁺+2e⁻→H₂O (2)
H₂+½O₂→H₂O (3)

As shown in equation 1, hydrogen forms protons (H⁺) and electrons. The protons flow through the electrolyte to the cathode side of the membrane electrode assembly, and the electrons flow from the anode side of the membrane electrode assembly to the cathode side of the membrane electrode assembly through the external load. As shown in equation 2, the electrons and protons react with oxygen to form water. Equation 3 shows the overall fuel cell reaction.

In addition to forming chemical products, the fuel cell reaction produces heat. One or more coolant flow field plates are typically used to conduct the heat away from the fuel cell and prevent it from overheating.

Each coolant flow field plate has an inlet region, an outlet region and channels that provide fluid communication between the coolant flow field plate inlet region and the coolant flow field plate outlet region. A coolant (e.g., liquid de-ionized water) at a relatively low temperature enters the coolant flow field plate at the inlet region, flows through the channels of the coolant flow field plate toward the outlet region of the coolant flow field plate, and exits the coolant flow field plate at the outlet region of the coolant flow field plate. As the coolant flows through the channels of the coolant flow field plate, the coolant absorbs heat formed in the fuel cell. When the coolant exits the coolant flow field plate, the heat absorbed by the coolant is removed from the fuel cell.

To increase the electrical energy available, a plurality of fuel cells can be arranged in series to form a fuel cell stack. In a fuel cell stack, one side of a flow field plate functions as the anode flow field plate for one fuel cell while the opposite side of the flow field plate functions as the cathode flow field plate in another fuel cell. This arrangement may be referred to as a bipolar plate. The stack may also include monopolar plates such as, for example, an anode coolant flow field plate having one side that serves as an anode flow field plate and another side that serves as a coolant flow field plate. As an example, the open-faced coolant channels of an anode coolant flow field plate and a cathode coolant flow field plate may be mated to form collective coolant channels to cool the adjacent flow field plates forming fuel cells.

### SUMMARY

The invention relates to methods of asynchronous diagnostics in a fuel cell or fuel cell system, as well as related fuel cells and fuel cell systems.

In some aspects, the invention includes a method that includes entering a diagnostic mode of a fuel cell in response to an asynchronous event. The method also includes analyzing, while in the diagnostic mode, data from at least one sensor or actuator to determine if a fault is present in the fuel cell system to provide analysis results and adjusting the operation of the fuel cell system based on the analysis results.

Embodiments can include one or more of the following. The at least one sensor can include a plurality of sensors. Entering a diagnostic mode can include entering a diagnostic mode in response to a triggering event. The triggering event can be a time based event. The time based event can be scheduled to occur during a low utilization period. The triggering event can be a fault based event. Adjusting the operation of the fuel cell can include shutting down the fuel cell or operating the fuel cell in a fault tolerant mode. Operating the fuel cell in a fault tolerant mode can include adjusting system parameters for the fuel cell. The method can also include exporting the analysis data to a data log. Analyzing data from a plurality of sensors can include grouping the data from the plurality of sensors and calculating indicators based on the data. The method can also include performing a test routine prior to adjusting the operation of the fuel cell. Adjusting the operation of the fuel cell can include adjusting parameters to increase the efficiency of the fuel cell. Analyzing data from the plurality of sensors can include matching sensor data to predefined fault signatures.

In other embodiments, a fuel cell system includes a plurality of state machines at a plurality of levels of the fuel cell system. Each of the state machines includes one or more start-up states, one or more operational states in which the fuel cell system is in operation, and one or more shutdown states in which the fuel cell system is in the process of shutting down or shutdown. The state machines also includes a fault tolerant state in which the fuel cell system is in operation using a set of reconfigured parameters to adjust the operation of the fuel cell based on a fault and a diagnostic state in which the fuel cell system is tested for faults. The diagnostic state is entered in response to an asynchronous event and includes a fault determination. The diagnostic state is exited based on the fault determination such that upon exit of the diagnostic state the fuel cell system enters one of the operational state, the fault tolerant state, and the shutdown state.

Embodiments can include one or more of the following. The plurality of levels of the fuel cell system can include one or more of a system level, a module level, a sub-system level, and a component level. The start-up states can include one or more of a configuring state, an on-line state, a start-up state, a warm-up state, a fill state, and a transition state. The shutdown states can include one or more of a shutdown state, an idle state, an off-line state, and a halt state.

In further embodiments, a method includes determining that a fault exists in a fuel cell system by comparing indicators of the fuel cell system to a set of faults, the indicators based on sensor data, testing the fuel cell system to determine if the fault is accurate to generate a set of test results, and determining an operational state based on the determined type of fault and the test results.

Embodiments can include one or more of the following. The operational state can include a shutdown state. The operational state can include a fault tolerant state. The method can also include adjusting system parameters based on the test results. The method can also include re-testing the fuel cell subsequent to adjusting the system parameters.

In additional embodiments, a computer program product, tangibly embodied in an information carrier, for executing instructions on a processor is operable to cause a machine to enter a diagnostic mode of a fuel cell in response to an asynchronous event. The computer program product also includes instructions to analyze, while in the diagnostic mode, data from at least one sensor or actuator to determine if a fault is present in the fuel cell system to provide analysis results and adjust the operation of the fuel cell system based on the analysis results.

In additional embodiments, a computer program product, tangibly embodied in an information carrier, for executing instructions on a processor is operable to cause a machine to determine that a fault exists in a fuel cell system by comparing indicators of the fuel cell system to a set of faults, the indicators based on sensor data, test the fuel cell system to determine if the fault is accurate to generate a set of test results, and determine an operational state based on the determined type of fault and the test results.

Other aspects, features, and advantages of the invention will be apparent from the description of the preferred embodiments thereof and from the claims.

### DESCRIPTION OF DRAWINGS

FIG. 1 is a block diagram of a fuel cell system.

FIG. 2 is a block diagram of the flow of information in a diagnostic mode of the fuel cell system of FIG. 1.

FIG. 3 is a table listing exemplary system conditions, faults, and actions.

FIG. 4 is a state diagram for the fuel cell system of FIG. 1.

FIG. 5 is a flow chart of an exemplary diagnostic routine.

FIG. 6 is a block diagram of a fuel cell having an external interface in communication with additional systems or units.

### DETAILED DESCRIPTION

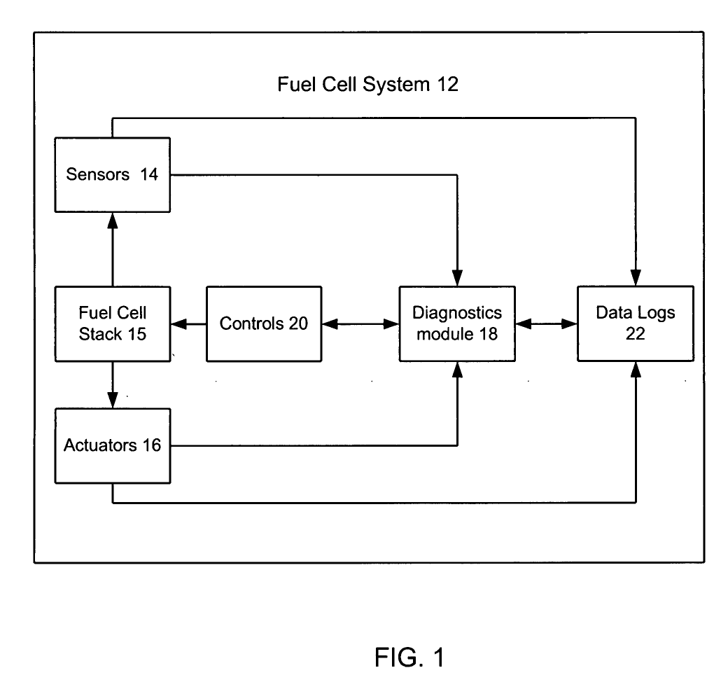

FIG. 1 is a block diagram of a fuel cell system 12 including a fuel cell stack 15, sensors 14, actuators 16, diagnostics module 18, controls 20, and data logs 22. Fuel cell stack 15 is in communication with sensors 14 and actuators 16 that monitor fuel cell stack 15.

Sensors 14 can monitor various aspects of fuel cell system 12. In general, a sensor is a device that responds to a physical stimulus (e.g., physical stimulus such as heat, light, sound, pressure, magnetism, composition, or motion) in fuel cell stack 15 and transmits or stores a result. Examples of sensors 14 include temperature sensors, product composition sensors, reactant flow rate sensors, product flow rate sensors, voltage sensors, current sensors, humidity sensors, and liquid water level sensors. In general, an actuator is an electrical or mechanical device for moving or controlling a component or operation of fuel cell system 12. Actuators 16 can be used for closed-loop regulation and modification of operational parameters for fuel cell stack 15 or can be used for open-loop controls such as diagnostics and system optimization (as described below). Examples of actuators 16 include mechanical, electrical, and/or pneumatic actuated devices that result in pressure, temperature, flow rates, and/or composition adjustments to reduce process error as indicated by sensor 14. A controller in fuel cell system 12 uses measurement data from sensors 14 and actuators 16 to modify the operation of a module, a subsystem, and/or a component (e.g., fuel cell stack, fuel processor, DC converter, AC inverter) of fuel cell system 12. For example, if a temperature reading from a particular sensor is high, fuel cell system 12 increases the amount of coolant flow to fuel cell stack 15. Data from sensors 14 and actuators 16 is stored in one or more data logs 22. In addition to data from sensors 14 and actuators 16, data logs 22 can store other system events, service notes, and system data such as constants, statistics and operational data. Data logs 22 provide a history of the operation of fuel cell system 12 and can be used by engineers, service personnel, and the customer to analyze the operation and performance of fuel cell system 12. Fuel cell system 12 can reference and use the information from data logs 22 to modify operation of fuel cell stack 15.

Diagnostics module 18 is in communication with sensors 14, actuators 16, and data logs 22. Diagnostics module 18 includes diagnostics routines and test procedures to analyze and adjust the operation of a module, a subsystem, and/or a component (e.g., fuel cell stack, fuel processor, DC converter, or AC inverter) of fuel cell system 12. For example, diagnostics module 18 can be used to determine the cause of a malfunction, abnormality, or failure in fuel cell stack 15. Fuel cell system 12 enters a diagnostics routine in response to indications generated based on data from sensors 14 and actuators 18.

Fuel cell system 12 also includes controls 20 that control aspects of the operation of modules, subsystems, and/or components of fuel cell system 12. Controls 20 can include control algorithms that are adaptive based on the operation of fuel cell system 12. For example, the control algorithms can modify the operation of fuel cell stack 15 over the operational lifetime of fuel cell stack 15 to account for component degradation, environmental changes (e.g., ambient temperature), and other changes in fuel cell stack 15. Controls 20 can also adjust the operation of fuel cell stack 15 based on the results of tests performed by diagnostics module 18.

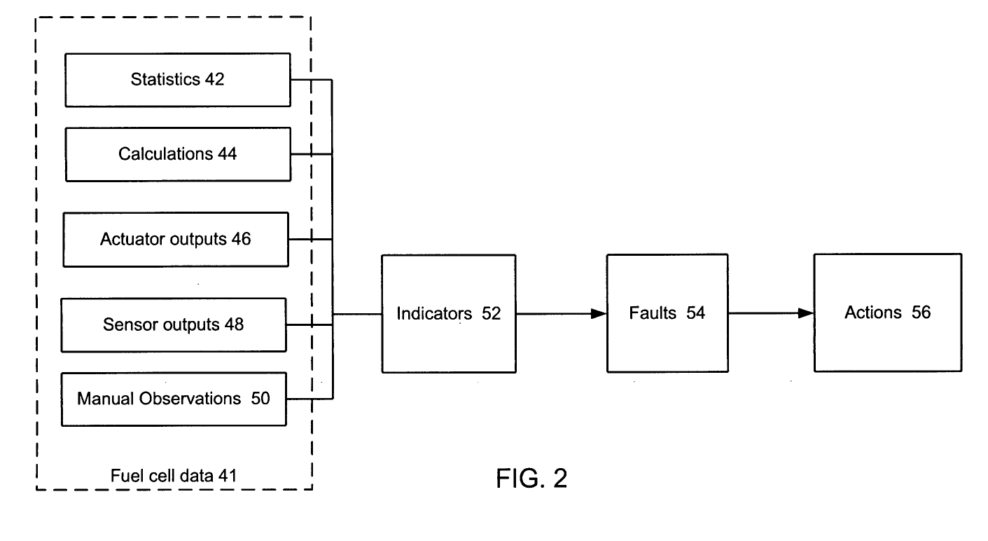

FIG. 2 is a block diagram that shows the use of fuel cell data 41 from sensors 14 and actuators 16 in addition to other data generated by fuel cell system 12 to generate indicators 52 and faults 54 which can be used to isolate the cause of a malfunction, abnormality, or problem in fuel cell stack 15. Fuel cell data 41 can also be used to determine corrective actions 56 based on the isolated problem. Fuel cell data 41 is collected or generated by fuel cell system 12 and can include sensor outputs 48 generated by sensors 14 and actuator outputs 46 generated by actuators 16. Fuel cell data 41 can also include manual observations 50, calculations 44, and statistics 42. Calculations 44 and statistics 42 can be based on data collected by fuel cell system 12 or based on data stored in data logs 22. Calculations 44 can include, for example, values calculated based on sensor outputs 48 and actuator outputs 46. Similarly, statistics 42 can be based on historic data stored in data log 22 or based on other fuel cell data 41. For example, statistics 42 can be used to determine trends in the operation of fuel cell stack 15 based on the drifting values or changes in a particular value or calculation 44 for one or more of sensor outputs 48 and actuator outputs 46 over a period of time.

Fuel cell data 41 can be used in a variety of ways to generate indicators 52. Fuel cell system 12 uses indicators 52 to monitor system performance and indicate the existence of a fault condition at the component-level or higher in fuel cell stack 15. Examples of indicators 52 include calculated values, statistics, system states, or parameters that can be classified to indicate a particular malfunction or status of fuel cell stack 15. Indicators 52 can be generated based on a single one of sensor outputs 48, actuator outputs 46, or manual observations 50. Alternatively or additionally, fuel cell system 12 generates indicators 52 based on a combination of fuel cell data 41 from multiple sensor outputs 48 and/or actuator outputs 52 that generate a particular result, calculation 44, or statistic 42. Multiple indicators 52 can be generated simultaneously and generated indicators 52 can be stored in data log 22.

In order to generate indicators 52, the fuel cell system controller uses a range of set points or a particular set point for a sensor 14. The range can be an acceptable range, e.g., a range in which fuel cell system 12 can operate without damaging fuel cell stack 15, or a desired range, e.g., a optimal range to operate fuel cell stack 15 efficiently and reduce wear on fuel cell stack 15. During operation of fuel cell system 12, sensors 14 measure values and compare the measured values to the set point or range of set points. Based on whether the measured value for sensor 14 lies within an acceptable or desired range, diagnostics module 18 generates indicators 52. In another example, values from one or more of actuators 16 may be used to generate indicators 52. Actuators 16 may also have a predefined acceptable range. If actuator 16 is measured to have values outside of the predefined range, an indicator 52 can be generated.

Values for indicators 52 indicate various conditions and failures in fuel cell system 12 and, based on indicators 52, faults 54 can be determined. In general, a fault is an isolated cause of a malfunction within fuel cell system 12. Faults 54 are determined based on combinations, signatures, or patterns of indicators 52. For example, if a certain set of indicators 52 are present for fuel cell system 12 faults 54 may be generated.

A single one of faults 54 or multiple faults 54 may be used to determine actions 56 (e.g., based on the results of the diagnostics state as described below). Actions 56 are used to change the operation of fuel cell stack 15 in response to faults 54 for fuel cell system 12. Examples of actions 56 include changing the operational state of fuel cell system 12, changing operation parameters for fuel cell system 12, and storing data in data log 22.

In general, the generation of indicators 52 and faults 54 allow fuel cell system 12 to systematically reduce the number of potential causes of a failure that has occurred in fuel cell stack 15. The relation between fuel cell data 41, indicators 52, faults 54, and actions 58 can logically be represented as a diagnostic fault tree that presents a hierarchical view of actions to correct system level failures through groupings of component level faults. The fault tree includes “and/or” logic to represent interactions between branches where each branch relates to a different type of system condition. For example, at the most basic level of the fault tree data from sensors 14 and actuators 16 is analyzed and the number of potential causes is reduced based on the patterns observed in sensors 14 and actuators 16 by the generation of indicators 52. The number of likely causes is further reduced based on patterns observed in indicators 52 during the generation of faults 54. Based on faults 54, actions 56 are determined. Thus, at each level in the fault tree the scope and number of potential causes of the malfunction are reduced resulting in the determination of actions used to correct or account for the malfunction.

For example, an acceptable temperature range for a component of fuel cell system 12 may be less than 200° C. If one of sensors 14 measures a value of 300° C., one or more indicators 52 may be generated to indicate a high temperature for the particular component associated with sensor 14. The generated indicators 52 can be combined with other indicators 52 to determine one or more faults 54. For example, if the temperature indicator is high and a coolant flow rate indicator signifies a lower than acceptable flow rate one or more faults 54 could be related to coolant flow in fuel cell system 12. To correct or modify the operation of fuel cell stack 15, an action 56 such as increasing the coolant flow could be generated.

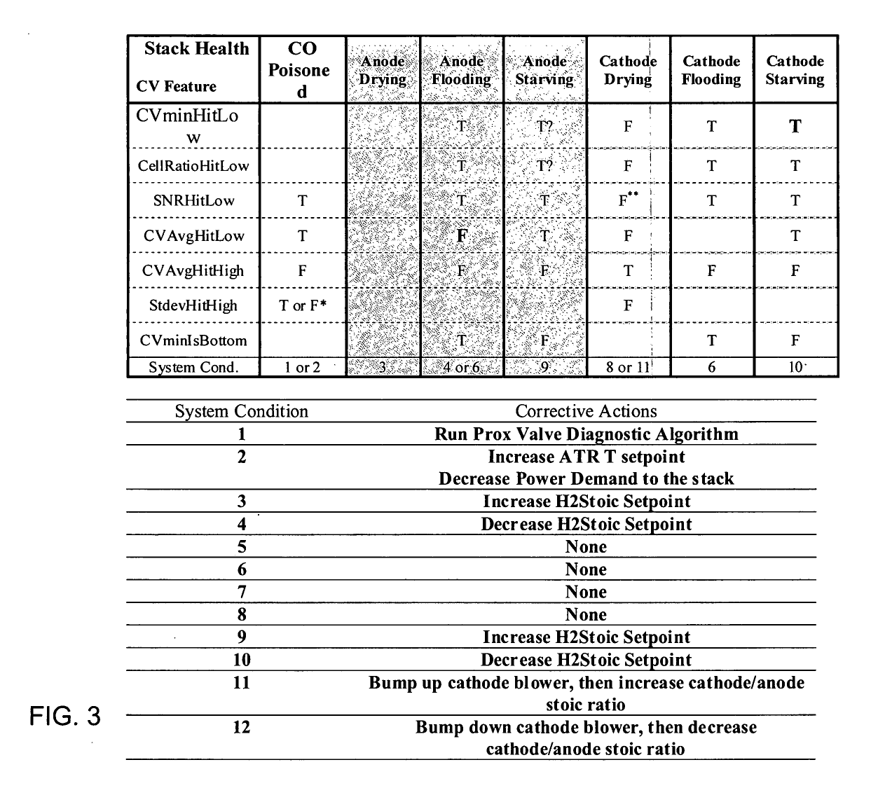

FIG. 3 shows an example of the determination of actions 56 based on faults 54 and indicators 52. Various indicators 52 are listed in the rows of table. In this embodiment, indicators 52 are true or positive/false or negative indications of a particular condition and are generated based on data collected from sensors 14 and actuators 16. Faults 54 (shown in columns of the table) are determined based on combinations of indicators 52 being present in fuel cell system 12. For example, a fault may require some indicators 52 to be present (e.g., true or positive) while additionally requiring other indicators 52 to be absent (e.g., false or negative). Not all indicators 52 generated by fuel cell system 12 are used to determine a particular fault, however, indicators not used to determine one fault may be used to determine other faults 54 in fuel cell system 12.

Based on the type of fault, one or more system conditions may be related to the fault (as indicated in the bottom row of the table shown in FIG. 3). For example, if a cathode drying fault exists multiple system conditions may have caused fault or be related to the fault. In order to determine one or more corrective actions 56 based on the fault when multiple system conditions are associated with the fault, additional test routines can be executed to determine the system condition causing the fault. Alternatively, a fuel cell technician could analyze faults 54 and determine the system condition causing the fault. Based on the system condition, various corrective actions 56 can be taken to correct or modify the operation of fuel cell system 12 to correct any existing faults 54.

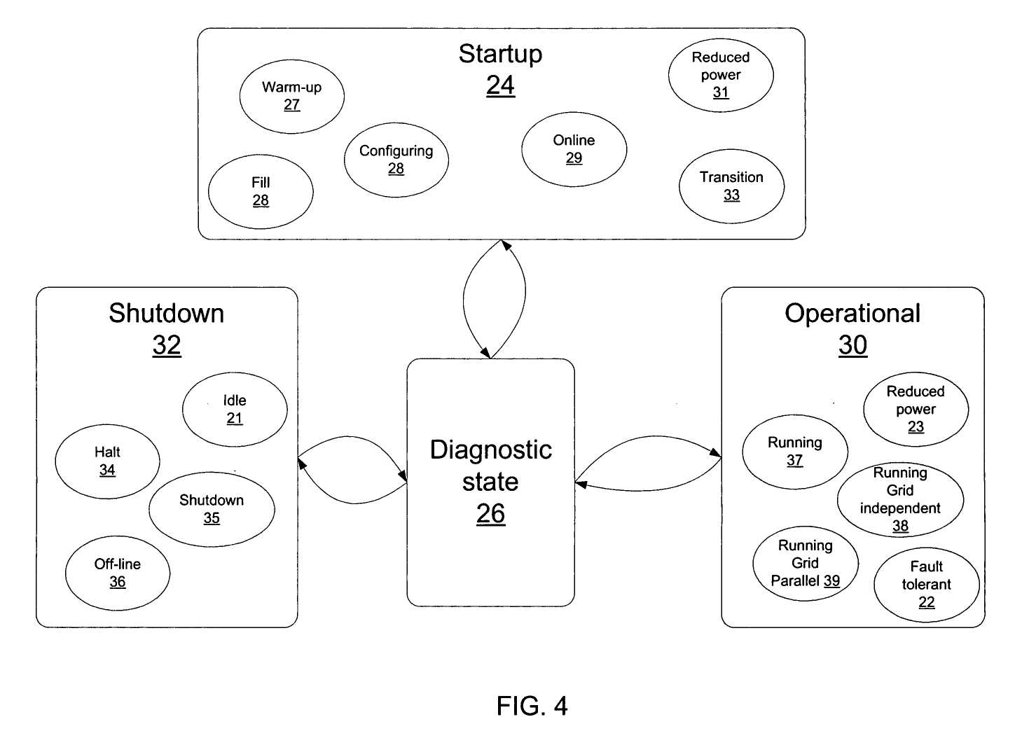

FIG. 4 shows a state diagram of some of the operational states of fuel cell system 12. Similar state diagrams may exist at one or more of the module level, subsystem level, and component level. The controller for each state machine can be centralized (e.g., fuel cell system controller) or local (e.g., fuel cell stack controller). In general, the state diagram shows the status (or operational state) of fuel cell system 12 at a given time and shows potential changes to the status or operational state based on inputs or events that cause fuel cell system 12 to exit one state and enter a different state. The various operational states can be generally categorized to include start-up states 24, operational states 30, shutdown states 32, and a diagnostics state 26.

Start-Up states 24 for fuel cell system 12, or modules, subsystems, or components thereof include a one or more of a configuring state 28, an on-line state 29, a warm-up state 27, a transition state 33, and a reduces power state 31. In general configuring state 28 is used to set configuration settings for fuel cell system 12 and during which fuel cell system 12 is initialized. On-line state 29 is used to wait for an external demand for power. Warm-up state 27 is used to prepare the system to meet the external demands. Transition state 33, or reduced power state 31 is used to transition from one of the start-up states 24 to one of the operational states 39. Operational states 30 (e.g., running) for the fuel cell system 12, modules, subsystems, or components include one or states during which fuel cell system 12 is operational and generating power. Operational states 30 can include one of more of a running state 37, a grid independent running state 38, a grid parallel running state 39, a reduced power state 23, and a fault tolerant mode or state 22. Shutdown states 32 for the fuel cell system 12, modules, subsystems, or components include one or more of a shutdown state 35 and halt state 34 during which fuel cell system 12 is in the process of shutting down, an idle state 21, and offline state 28 during which fuel cell system 12 is not in operation. Diagnostic state 26 for the fuel cell system 12, modules, subsystems, or components is used for testing fuel cell system 12 and determining actions 56 based on faults 54.

As described above, sensors 14 and actuators 16 generate fuel cell data 41 about the operation of fuel cell stack 15 (e.g., while fuel cell system 12 is running). Fuel cell data 41 is used to determine faults 54, and when particular faults exist in fuel cell system 12, fuel cell system 12 enters diagnostic state 26. Entering diagnostic state 26 is event driven, e.g., fuel cell system 12 enters diagnostic state 26 in response to an asynchronous event at any time during operation based on faults 54. An asynchronous event is an event that occurs at a time that is not easily predicted based on typical operation of fuel cell system 12, e.g., in response to a fault. Diagnostic state 26 can be entered from startup states 24, operational states 30, or shutdown states 32 based on the results of test routines and other diagnostic functions performed in diagnostics state 26, fuel cell system 12, upon exit of diagnostics state 26, can return to the same state or to a different state from the state fuel cell system 12 entered diagnostics state 26.

For example, during typical operation such as operation in running state 37 a fault may be generated causing fuel cell system 12 to enter diagnostic state 26. Based on the results of test routine(s) performed in diagnostic state 26, upon exit of diagnostic state 26 fuel cell system 12 may return to running state 37 or may enter a shutdown state 35 or another state (e.g., fault tolerant state 22).

In some embodiments, in addition to entering diagnostic state 26 based on an asynchronous event such as the occurrence of a particular fault, diagnostics state 26 can be entered in response to a synchronous event such as a timed event. Examples of synchronous events include entering diagnostic state 26 on a timed basis such as every 24 hours, after a predetermined number of hours fuel cell system 12 has been in operation. The diagnostic state 26 may be entered as a result of manual intervention. Diagnostics state 26 can also be entered in response to other synchronous events such as a condition based events (e.g., enter diagnostics subsequent to completion of a configuration routine).

As described above, fuel cell system 12 includes diagnostics state 26 and fuel cell system 12 enters diagnostic state 26 in response to either a synchronous or an asynchronous event. In some embodiments, entering diagnostic state 26 in response to asynchronous events reduces the down time of fuel cell system 12 by allowing fuel cell system 12 to be operated in a fault tolerant mode 22 with adjusted parameters. For example, fuel cell system 12 can include on-board information to determine if fuel cell system 12 can operate in a fault tolerant mode. Examples of such information include information about failure rate distributions, sensitivity to stresses, and impact of the customer for a failed component. A failed component can be a component that is not operational or a component that is operational but does not meet the requirements for normal operation. Using this information, control constants can be set to minimize the stress on the failed component allowing fuel cell system 12 to operate in some inferior or adjusted capacity. Since fuel cell system 12 is still at least partially operational in the fault tolerant mode, a service call may be delayed potentially reducing the maintenance cost of fuel cell system 12. In some embodiments, the use of diagnostics state 26 can additionally reduce the workload and service time for a technician to isolate and resolve faults by indicating the cause of the fault or limiting the potential causes of the fault to be investigated by the technician. In other embodiments, some faults may not require a technician to service fuel cell system 12. For such faults, fuel cell system 12 can log the fault but continue to operate without requiring the technician to service fuel cell system 12, thus reducing down time for fuel cell system 12.

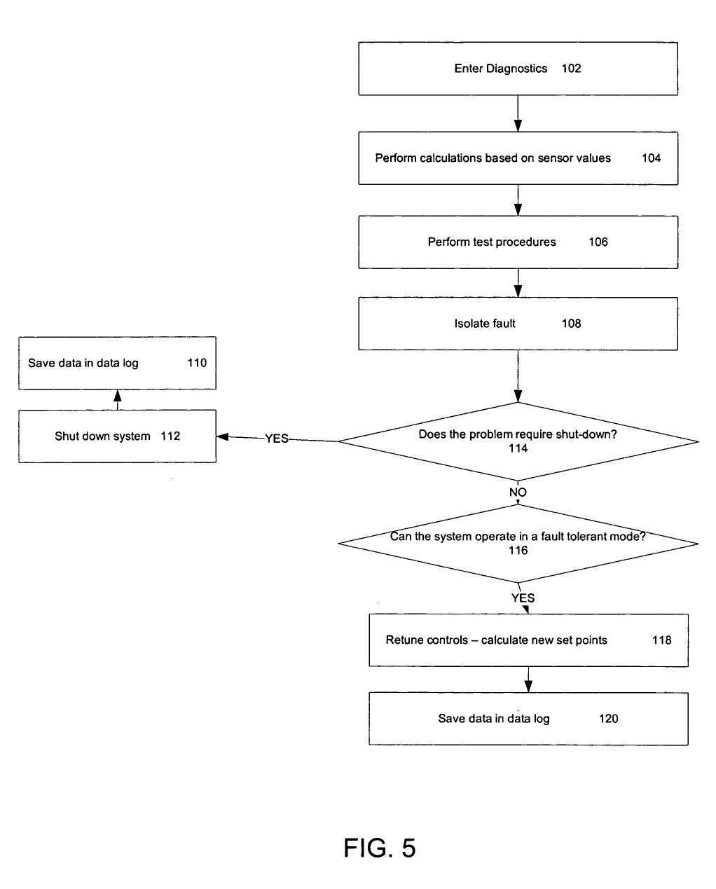

FIG. 5 shows a flow chart of an exemplary diagnostics routine performed in diagnostic state 26. As described above, diagnostic state 26 can be entered in response to a synchronous or asynchronous event (102). In diagnostic state 26, calculations are performed based on fuel cell data 41 (104). Results from the calculations can be used in addition to the generated fault code to isolate the cause of the fault. Based on the results of the calculations additional test procedures are performed to confirm or further define the cause of the fault (106). The test procedures in combination with the calculated sensor values can be used to isolate the fault (108).

Dependent on the fault present in fuel cell system 12 the actions taken by fuel cell system 12 often differ. Diagnostic state 26 includes determining if the isolated fault requires a complete shutdown of fuel cell (114). A shutdown may be required if the operation of fuel cell system 12 could harm fuel cell system 12, the environment, or people in close proximity to fuel cell system 12. If the fault requires a shutdown, fuel cell system 12 exits diagnostic state 26 and shuts fuel cell system 12 down (112). Additionally, data may be saved in data log 22 to record the cause of the fault and other information about the status of fuel cell system 12 (110). While some faults may involve a shutdown of fuel cell system 12, other faults may not require fuel cell system 12 to be shutdown and fuel cell system 12 can operate in a fault tolerant mode. Diagnostics state 26 determines if fuel cell system 12 can operate in a fault tolerant mode based on the type and/or severity of the fault (116). A fault tolerant mode can be a mode in which fuel cell system 12 functions in an impaired, but operable mode. For example, the fault tolerant mode could include operating fuel cell system 12 with modified operating rules (e.g., modified constant). Before exiting diagnostic state 26 to operate fuel cell system 12 in a fault tolerant mode, the controls can be retuned and new set points can be calculated (118). In addition, data can be saved in data log 22 for future reference (120).

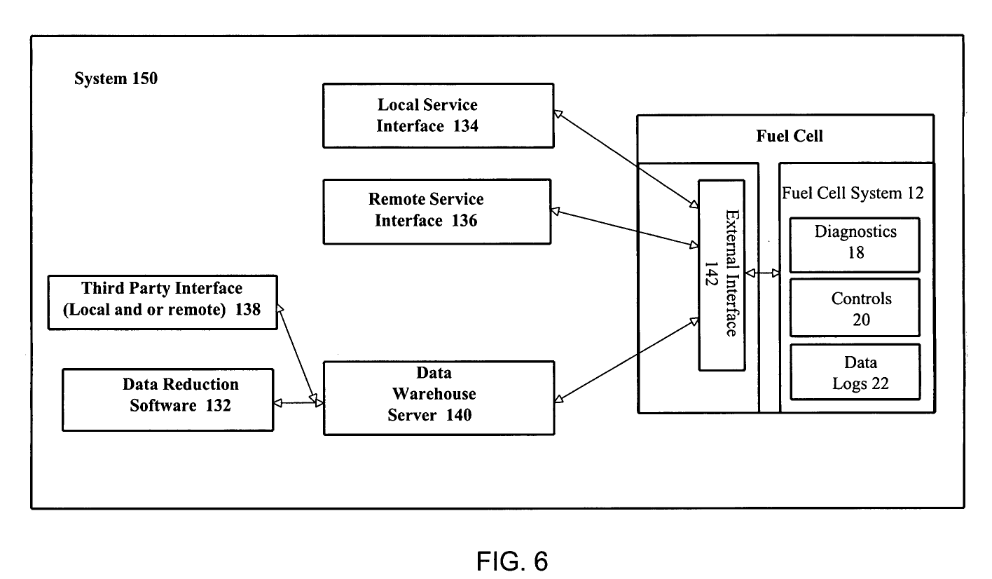

While embodiments have been described in which the processing of fuel cell data 41 is performed by fuel cell system 12, in some embodiments fuel cell data 41 could additionally or alternatively be processed by an external system or computer. For example, FIG. 6 shows a system 150 that includes fuel cell system 12, an external interface 142, a local service interface 134, a remote service interface 136, a third party interface 138, and a data warehouse server 140. Fuel cell system 12 can be in communication (e.g., communication over a network such as the internet, a direct wired connection, a phone line, or a wireless network) with one or more of local service interface 134, remote service interface 136, third party interface 138, and data warehouse server 140. The communication with an external system or computer allows some or all of the diagnostic processing and fault determination to occur via external interface 142.

Examples of local service interfaces include handheld service units operated by a service technician or engineer (e.g., third party provider, vendor, manufacturer, or customer). Manual operations and/or testing can occur on local service interface 134 either instead of or in addition to diagnostics performed by fuel cell system 12. For example, fuel cell system 12 may generate fuel cell data 41 and determine indicators and faults within fuel cell system 12. The faults may then be viewed by a technician via the local service interface to determine actions to be implemented on fuel cell system 12. Alternatively, the determination and implementation of actions can be completed within fuel cell system 12 and the local service interface 134 can be used to download information such as historical information about the operation of fuel cell system 12. Such historical information about faults 54 may be used to determine preventative maintenance to be performed on fuel cell system 12.

In embodiments in which fuel cell system 12 is in communication with a remote service interface 136, developmental and non-critical diagnostics (e.g., diagnostics that are in result to fault codes that indicate a malfunction in fuel cell system 12 that does not affect the immediate operation of fuel cell stack 15) can occur on remote service interface 136. This allows developmental and non-critical diagnostics to be tested and finalized before implementation on fuel cell system 12. Since a portion of the processing is moved from fuel cell system 12 to remote service interface 136, the computational intensity of fuel cell system 12 is reduced. This reduction in processing that occurs in diagnostic state 26 can also reduce the total time fuel cell system 12 is in diagnostic state 26 allowing fuel cell system 12 to operate for a greater proportion of the time in running state 30 during which power is generated.

In embodiments in which fuel cell system 12 is in communication with a third party interface 138 via a data warehouse server 140, some or all of fuel cell data 41 can be sent to data warehouse server 140. Data warehouse server 140 stores the information from data logs 22 retrieved from fuel cell system 12. Data logs 22 can be retrieved from fuel cell system 12 in a variety of ways, for example, by remotely accessing data logs 22 or downloading the information from data logs 22 using an interface to fuel cell system 12. Data logs 22 can be downloaded to data warehouse server 140 based on timed events (e.g., download the information every 10 minutes or every day) or in response to the occurrence of particular events in fuel cell system 12. Data reduction software 132 is used to analyze the data stored in data warehouse server 140. For example, the data reduction software 132 can be used in conjunction with third party interface 138 to determine if faults exist and to determine the problem that resulted in the fault. In this embodiment, the data processing in fuel cell system 12 during diagnostics state 26 can be limited and a greater amount of the processing and fault determination is performed on third party interface 138.

In some embodiments, fuel cell system 12 includes a back-up power supply, e.g., a battery. The back-up power supply can be used to supply power to devices connected to fuel cell system 12 when fuel cell system 12 is not generating power. For example, fuel cell system 12 may temporarily cease generating power during diagnostic state 26 while various testing routines are performed to isolate a fault. By supplying power from a back-up power supply, a customer will be affected less by the running of the diagnostic routine. Additionally, in some embodiments, based on the fault, fuel cell system 12 may run in a fault tolerant mode. In the fault tolerant mode, fuel cell stack 15 may generate a reduced amount of power. If fuel cell system 12 generates a reduced amount of power, the back-up power supply may be used to supplement the power from the fuel cell.

While embodiments have been described above in which fuel cell system 12 includes multiple sensors 14, other embodiments can include a single sensor. In embodiments that include a single sensor, the sensor may be configured to actuate multiple aspects of the fuel cell stack 15.

While embodiments have been described above in which fuel cell system 12 includes multiple actuators 16, other embodiments can include a single actuator. In embodiments that include a single actuator, the actuator may be configured to monitor multiple aspects of the fuel cell stack 15.

While embodiments have been described above in which the fuel cell stack 15 is in communication with sensors 14, actuators 16, and controls 20. Other arrangements of components in fuel cell system 12 are possible. For example, the fuel cell stack 15 could additionally be in direct communication with the diagnostics module 18.

While embodiments have been described above in which the fuel cell system 12 includes multiple data logs 22, fuel cell system 12 could include a single data log. In some embodiments fuel cell system 12 may not include a data log and data may be stored in another location (e.g., an external system) or the data may not be stored.

While embodiments have been described above in which the fuel cell system 12, can enter the diagnostics state 26 from any other state at the system, module, subsystem, or component level, the fuel cell system 12 may be configured to enter the diagnostics module 26 from a subset of other states.

Other embodiments are within the claims.

What is claimed is:

1. A method, comprising:
in response to an asynchronous event, entering a diagnostic mode of a fuel cell;
analyzing, while in the diagnostic mode, data from at least one sensor or actuator to determine if a fault is present in the fuel cell system to provide analysis results; and
adjusting the operation of the fuel cell system based on the analysis results.

2. The method of claim 1, wherein the at least one sensor includes a plurality of sensors.

3. The method of claim 1, wherein entering a diagnostic mode include entering a diagnostic mode in response to a triggering event.

4. The method of claim 3, wherein the triggering event is a time based event.

5. The method of claim 4, wherein the time based event is scheduled to occur during a low utilization period.

6. The method of claim 3, wherein the triggering event is a fault based event.

7. The method of claim 1, wherein adjusting the operation of the fuel cell includes shutting down the fuel cell.

8. The method of claim 1, wherein adjusting the operation of the fuel cell includes operating the fuel cell in a fault tolerant mode.

9. The method of claim 8, wherein operating the fuel cell in a fault tolerant mode includes adjusting system parameters for the fuel cell.

10. The method of claim 1, further comprising exporting the analysis data to a data log.

11. The method of claim 1, wherein analyzing data from a plurality of sensors includes:
grouping the data from the plurality of sensors; and
calculating indicators based on the data.

12. The method of claim 1, further comprising performing a test routine prior to adjusting the operation of the fuel cell.

13. The method of claim 1, wherein adjusting the operation of the fuel cell includes adjusting parameters to increase the efficiency of the fuel cell.

14. The method of claim 1, wherein analyzing data from the plurality of sensors includes matching sensor data to predefined fault signatures.

15. A fuel cell system, comprising:
A plurality of state machines at a plurality of levels of the fuel cell system, each of the state machines comprising:
one or more start-up states;
one or more operational states in which the fuel cell system is in operation;
one or more shutdown states in which the fuel cell system is in the process of shutting down or shutdown;
a fault tolerant state in which the fuel cell system is in operation using a set of reconfigured parameters to adjust the operation of the fuel cell based on a fault; and
a diagnostic state in which the fuel cell system is tested for faults;
wherein:
the diagnostic state is entered in response to an asynchronous event,
the diagnostic state includes a fault determination, and
the diagnostic state is exited based on the fault determination such that upon exit of the diagnostic state the fuel cell system enters one of the operational state, the fault tolerant state, and the shutdown state.

16. The fuel cell system of claim 15, wherein the plurality of levels of the fuel cell system include one or more levels selected from the group consisting of a system level, a module level, a sub-system level, and a component level.

17. The fuel cell system of claim 15, wherein the start-up states include one or more states selected from the group consisting of a configuring state, an on-line state, a warm-up state, a fill state, a reduced power state, and a transition state.

18. The fuel cell system of claim 15, wherein the shutdown states include one or more states selected from the group consisting of a powerdown state, an idle state, an off-line state, and a halt state.

19. A method, comprising:
determining that a fault exists in a fuel cell system by comparing indicators of the fuel cell system to a set of faults, the indicators based on sensor data;
testing the fuel cell system to determine if the fault is accurate to generate a set of test results; and
determining an operational state based on the determined type of fault and the test results.

20. The method of claim 19, wherein the operational state includes a shutdown state.

21. The method of claim 19, wherein the operational state includes a fault tolerant state.

22. The method of claim 19, further comprising adjusting system parameters based on the test results.

23. The method of claim 22, further comprising re-testing the fuel cell subsequent to adjusting the system parameters.

24. A computer program product, tangibly embodied in an information carrier, for executing instructions on a processor, the computer program product being operable to cause a machine to:
in response to an asynchronous event, enter a diagnostic mode of a fuel cell;
analyze, while in the diagnostic mode, data from at least one sensor or actuator to determine if a fault is present in the fuel cell system to provide analysis results; and
adjust the operation of the fuel cell system based on the analysis results.

25. A computer program product, tangibly embodied in an information carrier, for executing instructions on a processor, the computer program product being operable to cause a machine to:
determine that a fault exists in a fuel cell system by comparing indicators of the fuel cell system to a set of faults, the indicators based on sensor data;
test the fuel cell system to determine if the fault is accurate to generate a set of test results; and
determine an operational state based on the determined type of fault and the test results.
